(19) United States
(12) Patent Application Publication
(10) Pub. No.: US 2012/0026276 A1
(43) Pub. Date: Feb. 2, 2012

(54) Manner of ranging items on the computer monitor screen surface, especially key words for the requirements of web browser users

(76) Inventors: Andrzej Czyzewski, Gdynia (PL); Bozena Kostek, Gdynia (PL); Rafal Rybacki, Ostroda (PL)

(21) Appl. No.: 13/136,235

(22) Filed: Jul. 27, 2011

(30) Foreign Application Priority Data
Jul. 27, 2010 (PL) P.391974

(51) Int. Cl. H04N 7/14; H04N 7/18

(52) U.S. Cl. 348/14.05; 348/78; 348/E07.083; 348/E07.085

(57) ABSTRACT

The manner of measuring the location of user's eyesight fixation point on the computer screen surface based on illuminating the eye surface, monitoring the eye with a camera and analysing light reflecting from the pupil surface is characterized by the fact that sources of illumination are installed in the camera axis, and in corners of computer monitor and/or somewhere near them. This light is an infrared light and depending on features characteristic for the eyes of the user, sources of illumination are turned on or turned off in sequence or jointly, and then, constellations of reflections from pupil's surface are recorded in camera image, whereas the camera image is transferred to undergo processing by the computer and by software.

The object of the invention is the manner of measuring the location of user's eyesight fixation point on the computer screen surface and a system to measure the location of user's eyesight fixation point on the computer screen surface. The object of the invention is also focused on practical usage of means of measuring the location of user's eyesight fixation point on the computer screen surface.

The manner of ranging items on the computer monitor screen surface, especially key words for the requirements of web browser users with the use of measurement concerning the location of the user's eyesight fixation point on the surface of the computer monitor screen constitutes the subject of the invention.

According to the invention the manner of ranging items on the computer monitor screen surface, especially key words for the requirements of web browser user lying in monitoring the eye with a camera in the course of subsequent turning off and turning on the sources of light, recording constellations of reflections from pupil's surface in the camera image and processing the camera image by the computer and software, and as a result on establishing eyesight fixation points, is characterised by the fact that it measures the relation between the period of time when the user covered the area of the selected surface of the presented object with his eyes, and the overall period when the entity was displayed, and/or it measures the relation between the surface covered with user's eyes and the overall surface of the displayed element.

According to the invention, another variant of the invention is characterised by the fact that it traces the movement of user's eyesight on the surface of the displayed object, and when the eyesight reaches the final fragment of the object, positive key word, or letter, or note, another object is being displayed, the following page of an e-book or a note chart.

Using the invention allows to ensure quicker search of objects from all repositories, including the ones found in the Internet.

What is already known is the ranging of materials during search for documents, from software repository in the Internet network based on countable information, such as number of material activations, number of clicks and number of downloads.

Specialists also know manners of measuring user's eyesight fixation point on the surface of the computer screen based on illuminating the surface of the eye and monitoring the eye with a camera, and then analysing reflections of the light from pupil's surface.

Polish patent description No. P.391974 contains a depiction of fixation characterised by the fact that sources of illumination operating within the scope of infrared light are installed in the camera axis and in corners of the computer monitor and/or somewhere near them. Then, depending on features characteristic for the eyes of the user, light sources are activated or inactivated, in sequence or jointly. Constellations of reflections from pupil's surface obtained due to the above-mentioned method are recorded in camera image, and the camera image is transferred to undergo processing by the computer and by software.

There are already systems following the eyesight point, which basing on the above determines the eyesight fixation point. These systems are divided into contact ones and contact-free, according to their manner of interaction with the user.

The first group of systems requires the user to wear a special helmet or another construction, where the special equipment shall be installed. U.S. Pat. No. 7,401,920 patent description contains a solution which depicts a helmet with attached camera, which follows the eyeball movement from a very close distance. U.S. Pat. No. 6,299,308 patent elaboration contains a description of a construction placed on user's head equipped with special glasses, including not only illuminators, but also detectors. These glasses make it possible to indicate the direction of user's eyesight fixation.

The second group of systems is characterized by the fact that it takes advantage of illuminating different parts of the eye by various kinds of light, as well as monitoring light reflections from surfaces of various eye parts. The description of U.S. Pat. No. 6,758,563 patent depicts a solution basing on the fact that the eye is illuminated with a glue light and this allows detecting the point with greatest absorption on the retina. Detecting this point enables to determine the direction of eye fixation. U.S. Pat. No. 6,659,611 patent description contains a solution related with operation within the scope of infrared light generated by illuminators, which creates a constellation of reflexes on the surface of human iris. Analysis of these reflections as well as determination where pupil's centre is located allows establishing user's eyesight fixation point.

According to the invention, the manner of measuring the location of user's eyesight fixation point on the computer screen surface based on illuminating the eye surface, monitoring the eye with a camera and analysing light reflecting from the pupil surface. What is more, it is characterized by the fact that sources of illumination are installed in the camera axis, and in corners of computer monitor and/or somewhere near them. This light is an infrared light and depending on features characteristic for the eyes of the user, sources of illumination are turned on or turned off in sequence or jointly. Then, constellations of reflections from pupil's surface are recorded in camera image, whereas the camera image is transferred to undergo processing by the computer and by software.

According to the invention, the system measuring the location of user's eyesight fixation point on the computer screen surface containing eye illuminators, camera and the computer with software is characterized by the fact that eye illuminators, positive LED diodes working within infrared range, are placed in the positively dedicated camera axis and in corners of computer monitor and/or close to them. As the description states, the invention also contains a device used to control the light-generating mode through eye illuminators.

What concerns the realization variant of the system, the invention states that the camera has an installed optical band-flow filter together with matrix, which has an embedded image of the face with image of user's eyes.

In another variant of the invention the camera is equipped with a programmer controlling the perpendicular and horizontal position of camera lens.

The system used to perform visual monitoring of remote objects is an invention in which the manner of measuring the location of user's eyesight fixation point on the computer screen surface is put into practice. The system has remote cameras, network interface and central monitoring controlling application, as well as a computer with monitor, used by the person conducting the monitoring. The invention is characteristic due to the fact that the computer of the person performing the monitoring is equipped with a system measuring the eyesight fixation point of this person and remote cameras equipped with programmers controlling the perpendicular and horizontal position of camera lens. The system is equipped with controlling application, which enables magnifying and observing details in monitor frame and/or obtaining the image of objects in monitor frame by shifting the eyesight fixation point outside the monitor frame.

Another invention where the manner of measuring the location of user's eyesight fixation point on the computer screen surface was used is the teleconference system equipped with remote camera, network interface, teleconference controlling application, next to computers with monitors used by teleconference participants. What is characteristic for this invention is the fact the computer of the person taking part in the conference is equipped with system measuring the eyesight fixation point of this person, whereas the remote camera is equipped with programmer controlling the perpendicular and horizontal position of remote camera lens. According to this invention the system has an application managing the video image displayed on the screen, depending on the point where the eyesight of the teleconference participant is fixed.

Yet another invention where the manner of measuring the location of user's eyesight fixation point on the computer screen surface was utilized is the system supporting reading text on a monitor by people with dyslexia. As far as this method is concerned, the computer is equipped with a system to measure the location of user's eyesight fixation point, and after this person fixates his or her eyesight on the fragment of the read text visible on the monitor, letters and/or numbers in the read text are magnified, so that the letter and/or number within the line on which the eyesight is focused was the biggest one, while adjoining letters and/or numbers were smaller and smaller. Magnification of letters or numbers takes place according to the elaborated algorithm.

The invention is described in detail in realization examples and in the illustration, where figures present as follows:

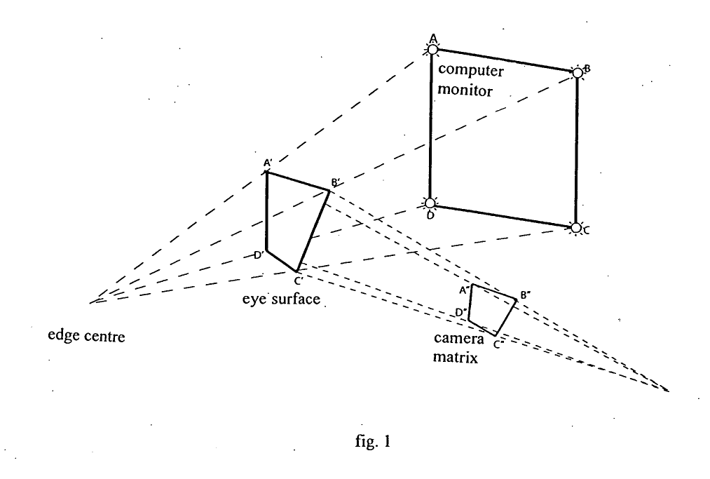

FIG. 1—the registration scheme through camera matrix for illuminators' reflections from the eye surface,

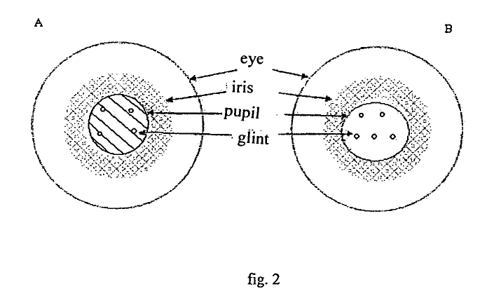

FIG. 2—symbolic image of the eye with dark pupil and light pupil effect,

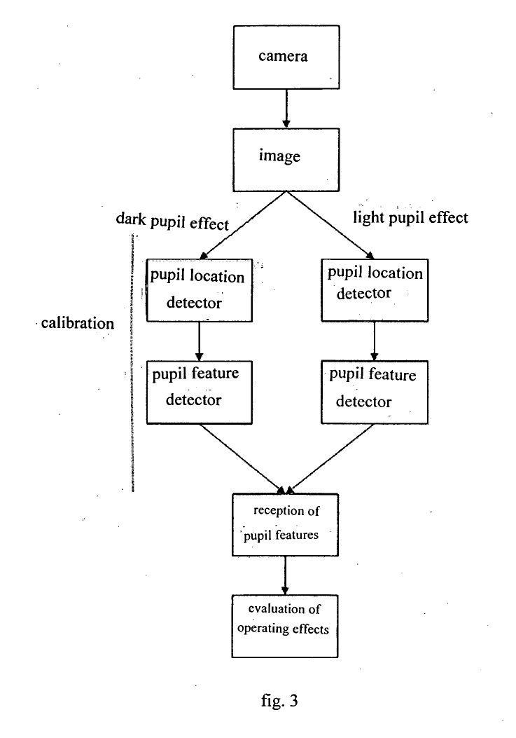

FIG. 3—scheme related with selecting the working mode for eyesight fixation point measuring system,

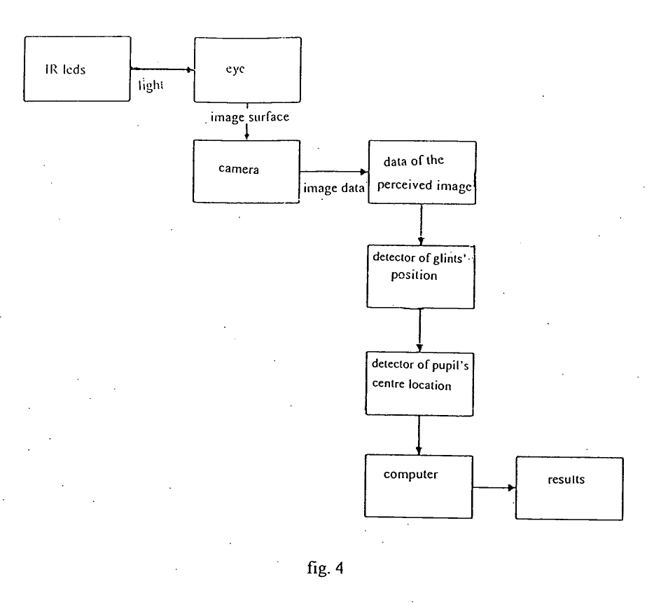

FIG. 4—eyesight fixation point measuring system operating scheme

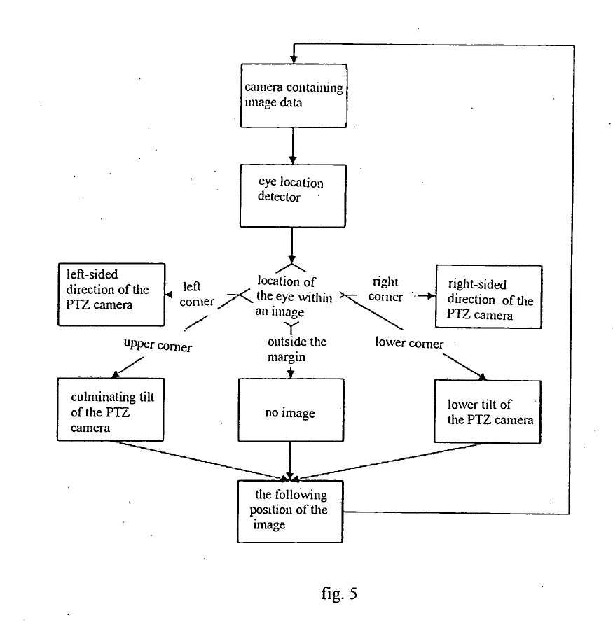

FIG. 5—scheme related with controlling the camera by the programmer,

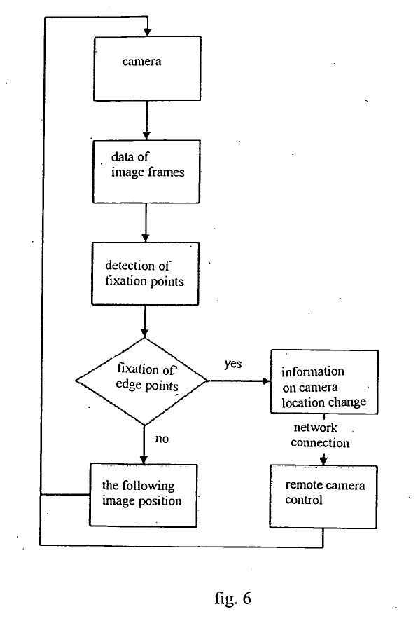

FIG. 6—scheme related with controlling the remote camera by the programmer,

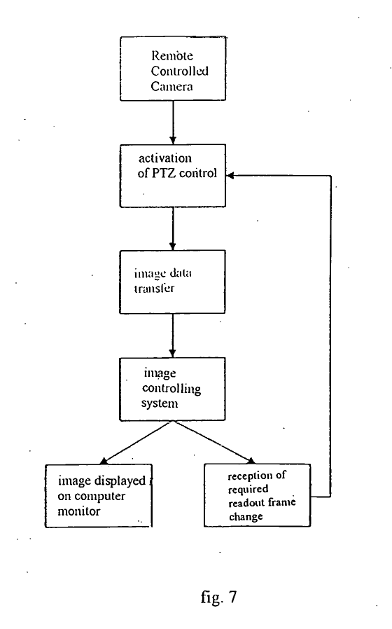

FIG. 7—teleconference system operating scheme,

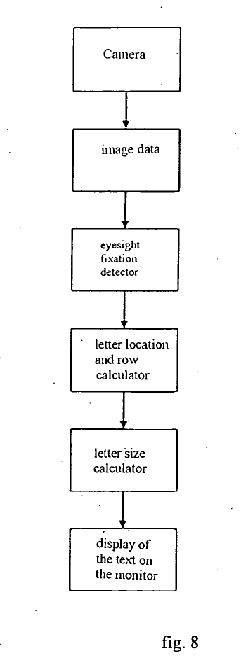

FIG. 8—scheme related with the method supporting reading texts on computer monitor by people with dyslexia,

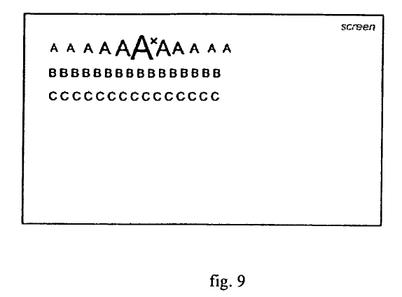

FIG. 9—symbolic fragment of the text visible on the monitor anticipated to support reading,

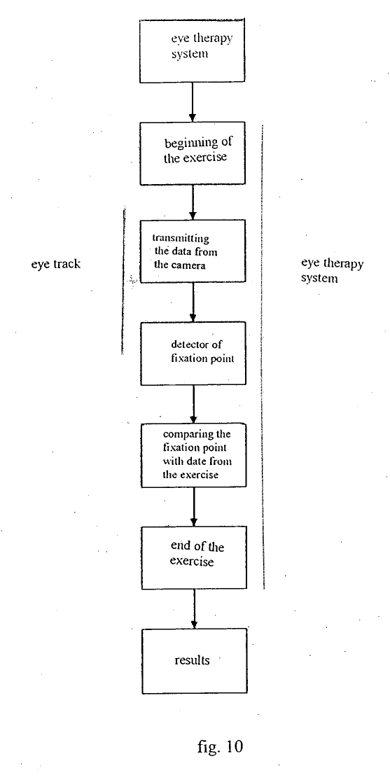

FIG. 10—scheme focusing on using the method depending on eyesight therapy,

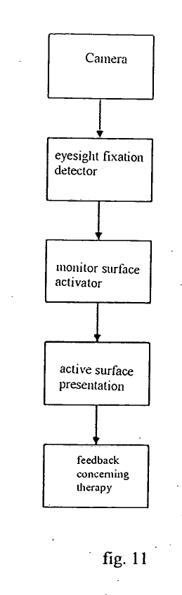

FIG. 11—scheme related with using the method to contact people in a vegetative condition.

### EXAMPLE 1

### Ranging the Key-Word in the Field of the Internet Search Engine

Sources of light are being installed in the camera axis and in the corners of computer monitor. After entering the key word by the Internet user in the field of the Internet search engine, the user obtains a list of texts in a given sequence. When searching through particular positions from the list, the user accepts or rejects them.

During subsequent turning on and turning off light sources, the eye of the user is being monitored with the use of a camera and constellations of reflections from pupil's surface are being recorded in the camera image, and then the camera image is processed by the computer and computer software. This is how user's eyesight fixation points are being determined. Then the device measures the relation between the time when the user aimed to look at the area of the selected surface from the displayed list of texts and the overall period of time when the list of texts was displayed, taking advantage of computer software. The overall time essential to cover positions on the list with user's eyes stands as the measurement of user's interest with particular positions from this list.

### EXAMPLE 2

### Ranging Sought Elements in a Video Material

Light sources are located in relation to the camera and computer monitor, as it has been stated in example 1. The Internet user, when searching through the video material with the aim to find interesting objects, focuses his eyesight on the element he found interesting.

During subsequent turning the light sources on and off, the eye of the user is monitored by a camera and the device records constellation of reflections from pupil's surface in camera image, and then the image of the camera is processed by the computer and computer software. This is how the Internet user's eyesight fixation points are being determined. Then the device measures the relation between time when the user covered the area of the selected element with his sight on purpose or involuntarily, and the total time of displaying the object. What the computer software also measures is the surface of the element covered with eyesight in relation to the overall surface of the displayed object. The time necessary to cover particular positions together with the surface of the element covered with the eyes stand as the measurement of user's interest with particular objects.

### EXAMPLE 3

### Ranging the Last Letter in an E-Book

Light sources are located in relation to the camera and computer monitor, as it has been stated in example 1. When the Internet user looks through an e-book, he focuses his eyes on particular lines of the displayed page of the e-book. The device monitors the way the user's eyesight shifts in the manner described in example 1. The point of user's eyesight fixation is set on the last letter on the page of the e-book. Then the following page of this e-book will be displayed.

### EXAMPLE 4

### Ranging the Last Note in the Note Chart

Light sources are located in relation to the camera and computer monitor, as it has been stated in example 1. When the Internet user looks at the electronic note chart, he focuses his eyes on particular lines of the displayed page of the note chart. The device monitors the way the user's eyesight shifts in the manner described in example 1. The point of user's eyesight fixation is set on the last note on the page of the note chart. Then the following page of the note chart will be displayed.

### EXAMPLE 5

### Ranging of the Key Word in the Internet Search Engine

As a result of entering the key word by the Internet user in the field of the Internet search engine, the user obtains a list of texts in a given sequence. When searching through particular positions from the list, the user accepts or rejects them in various ways. The time essential to cover these items with eyesight stands as the measurement of user's interest in particular positions from the list. According to the invention the device measures the relation between time when the user looked at the area of the selected surface from the displayed list of texts and the overall period of time when the list of texts was displayed.

### EXAMPLE 6

### Ranging of Sought Elements in Video Material

When searching through the video material to find objects he is interested in, the Internet user focuses his sight on the element he found interesting. According to the invention, the device measures the relation between time when the user covered the area of the selected element with his sight and the total time of displaying the object. What is also measured is the surface of the element covered with eyesight in relation to the overall surface of the displayed object.

### EXAMPLE 7

### Method and System Measuring and Analysing User's Eyesight Fixation Point on Computer Screen

System measuring and analysing user's eyesight fixation point on computer screen contains a computer set including monitor, set of illuminators and a camera recording the image of user's face. As it can be seen in FIG. 1, there are four illuminators—A, B, C, D—constituting point light sources in form of LED diodes, generating infrared light. What is more, there is an additional camera fixed on the camera axis. The light generated by illuminators, light of fixed intensity is to generate reflections on the surface of the eye, whereas the set also contains a programmer controlling the mode of light generation by illuminators. Illuminators on corners of the monitor are to generate single, point reflections called glints, whereas illuminators placed on camera axis will generate reflection from the surface of the whole pupil. Activation or inactivation of illuminators lead to creation of various eye images.

As it can be seen in FIG. 1B, with all illuminators active we have a light pupil effect, whereas as it is shown in FIG. 1A, in case of activating part of illuminators, with assumption that the light intensity is adjusted to meet appropriate requirements, the pupil of the eye remains unlit and there is the dark pupil effect generated on the eye. As shown in FIG. 3, both effects were used because of the diversity related with characteristic features of the eye in various users, as well as due to differences in background illumination levels.

Using these two effects allows making them independent of physical features characteristic for user's eye and light conditions in the room. Decision to use any of these modes is made during system calibration and may be changed by the user.

As it can be seen in FIG. 4 illumination of the background reflected from the eye, as well as artefacts cause by the light from illuminators, reach the dedicated camera together with the image of the face, and the dedicated camera enables to work within infrared range. The camera has a band-flow filter installed, which selects required lengths of the light falling within the infrared scope and generated by the illuminators. The aim of using the filter is to eliminate interferences and artefacts caused by external lighting. Image of user's face together with his or her eyes is set on CCD camera matrix, which is also sensitive within the infrared scope.

The image generated by the camera undergoes further processing by the generated algorithm. The objective of the algorithm is to establish the eyesight fixation point on the computer screen basing on the image sent from the camera. In relation with the above, data of the image are processed and all variables necessary to establish the result are being indicated. Coordinates stating location of pupil's centre stated in coordinates within the image are indicated in the first place. Then, following the same methodology, positions of glints, namely reflections from illuminators on the surface of the eye, are indicated. Relation between the location of glints and the location of the pupil's centre reflects the geometrical conversion of the eyesight fixation point in respect to illuminators located on corners of the monitor. Eyesight fixation point is indicated on the basis of this relation.

### EXAMPLE 8

### System Measuring and Analysing User's Eyesight Fixation Point on Computer Screen with the Possibility to Follow Movements of the User's Head

The system is realised basing on the same principle as in example No. 1, but in this case the camera is equipped with a PTZ (pan-tilt-zoom) controller, which allows controlling the perpendicular and horizontal position of camera lens. As it can be seen in FIG. 5, the image from the camera is processed and during this processing it is possible to obtain the location of the eyes within the frame. If the location of the eyes is getting closer to any edge of the image, a command controlling the camera PTZ controller is automatically activated to maintain an appropriate frame. If the eyes are close to the upper edge, the camera moves upwards, etc.

### EXAMPLE 9

### System Used to Ensure Visual Monitoring of Remote Locations

The system contains remote cameras, network interface, central monitoring controlling application and a computer with screen used by the person conducting the monitoring process. Computer of the person conducting the monitoring process is equipped with a system measuring the eyesight fixation point of this person, and remote cameras have PTZ (pan-tilt-zoom) controllers, which control the perpendicular and horizontal position of camera lens. The system has a controlling application, which allows magnifying and perceiving details in the monitor frame, as well as obtaining images within the monitor frame by shifting the eyesight fixation point outside the monitor frame.

As it can be seen in FIG. 6, controlling is activated when the application user focuses his or her sight near any of the edges of the image. In such case the algorithm accepts that the area interesting for the user may be located somewhere outside the current image frame. Due to the above, the remote camera receives a command through network interface to activate the PTZ controller and turn the camera. This shall be performed until the system reaches a point when the eyesight of the user shall rest in the middle of camera frame, and this will mean that the area of the frame, which the user finds interesting is in the middle part and is most probably entirely visible in the frame.

### EXAMPLE 10

### System Used to Conduct Teleconference

System used to conduct teleconferences contains a remote camera, network interface, teleconference managing application as well as computers with monitors use by people participating in the teleconference. The computer of the person taking part in the conference is equipped with system measuring the eyesight fixation point of this person, whereas the remote camera is equipped with programmer controlling the perpendicular and horizontal position of remote camera lens. The system has an application managing the video image displayed on the screen, depending on the point where the eyesight of the teleconference participant is fixed.

FIG. 7 shows that the camera operating remotely within a location, where the conference is being held sends the image through the network to the managing application. The managing application displays the video image on the screen and controls not only the work, but also the results of the system tracking the eyesight fixation point. The application analyses user's eyesight fixation point on a regular basis, and if necessary, sends the activation command to PTZ controller in order to activate the motor positioning camera lens. This results in change of video image frame content sent from the remote location.

### EXAMPLE 11

### Method Related with Supporting Reading Texts on Computer Monitor by Various People, and in Particular Persons with Dyslexia

The computer is equipped with system measuring the location of user's eyesight fixation point. After a person fixates his or her eyesight on the fragment of the read text visible on the monitor, letters and/or numbers in the read text are magnified, so that the letter and/or number within the line on which the eyesight of the given person is focused was the biggest one, while adjoining letters and/or numbers were smaller and smaller, and this is shown in FIG. 8 and FIG. 9. Magnification of letters or numbers takes place according to the elaborated algorithm.

### EXAMPLE 12

### Amblyopia—Diagnosis and Therapy

Diagnosis and therapy related with amblyopia is conducted with the help of a dedicated application, which enables the user to perform a series of exercises aiming to stimulate the proper functioning of the visual organ. What is advantageous in such exercises is the information on the eyesight fixation point on computer screen, and the information on eyesight fixation point is used for each of the eyes independently.

As it is shown in FIG. 10, the eyesight fixation point is indicated on the basis of the image frame sent from the system camera. Then the position of indicated eyesight fixation point on the computer screen is used to activate or change the elements located within the given area of the screen. This change may lie in showing, magnifying, decreasing, and indicating the given fragment of the screen, text or graphics located within the given fragment of the screen. Due to the above both the user and the person assisting the user shall obtain feedback concerning the point at which the user is looking.

### EXAMPLE 13

### Using the Invention to Contact People in a Vegetative Condition

People in a vegetative condition cannot take full advantage of communication capabilities typical for humans and quite often the only organ, which allows them to communicate, is the visual organ. This invention is used as an extension of communication possibilities of such people or as a form of therapy, which aims to increase the level of communicativeness in such persons.

As shown in FIG. 11, the eyesight fixation point is set basing on the image obtained from systemic camera. Then the position of indicated eyesight fixation point on the computer screen is used to activate or change the elements located within the given area of the screen. This change may lie in showing, magnifying, decreasing, and indicating the given fragment of the screen, text or graphics located within the given fragment of the screen. Due to the above both the user and the person assisting the user shall obtain feedback concerning the point at which the user is looking.

1. According to the invention, the manner of measuring the location of user's eyesight fixation point on the computer screen surface based on illuminating the eye surface, monitoring the eye with a camera and analysing light reflecting from the pupil surface is characterized by the fact that sources of illumination are installed in the camera axis, and in corners of computer monitor and/or somewhere near them. This light is an infrared light and depending on features characteristic for the eyes of the user, sources of illumination are turned on or turned off in sequence or jointly, and then, constellations of reflections from pupil's surface are recorded in camera image, whereas the camera image is transferred to undergo processing by the computer and by software.

2. According to claim 1, the system measuring the location of user's eyesight fixation point on the computer screen surface containing eye illuminators, camera and the computer with software is characterized by the fact that eye illuminators, positive LED diodes working within infrared range, are placed in the positively dedicated camera axis and in corners of computer monitor and/or close to them. As the description states, the invention also contains a controller used to control the light-generating mode through eye illuminators.

3. According to claim 2, the system is characterised by the fact that the camera has an installed optical band-flow filter together with matrix, which has an embedded image of the face with image of user's eyes.

4. According to claim 2, the system is characterised by the fact that the camera is equipped with a programmer controlling the perpendicular and horizontal position of camera lens.

5. According to claim 1, the system used to perform visual monitoring of remote objects containing remote cameras, network interface and central monitoring controlling application, as well as a computer with monitor, used by the person conducting the monitoring is characterised by the fact that the computer of the person performing the monitoring is equipped with a system measuring the eyesight fixation point of this person, whereas remote cameras are equipped with programmers controlling the perpendicular and horizontal position of camera lens, and the system is equipped with controlling application, which enables magnifying and observing details in monitor frame and/or obtaining the image of objects in monitor frame by shifting the eyesight fixation point outside the monitor frame.

6. According to claim 1, the system used to conduct teleconference equipped with remote camera, network interface, teleconference controlling application, next to computers with monitors used by teleconference participants is characterised by the fact that the computer of the person taking part in the conference is equipped with system measuring the eyesight fixation point of this person, whereas the remote camera is equipped with programmer controlling the perpendicular and horizontal position of remote camera lens, and the system is equipped with an application managing the video image displayed on the screen, depending on the point where the eyesight of the teleconference participant is fixed

7. According to claim 1, the system supporting reading the text on the monitor by people, especially people suffering from dyslexia is characterised by the fact that the computer is equipped with a system to measure the location of user's eyesight fixation point, and after this person fixates his or her eyesight on the fragment of the read text visible on the monitor, letters and/or numbers in the read text are magnified, so that the letter and/or number within the line on which the eyesight is focused was the biggest one, while adjoining letters and/or numbers were smaller and smaller, whereas magnification of letters or numbers were smaller and smaller, whereas magnification of letters or numbers takes place according to the elaborated algorithm.

8. According to claim 1, the manner of ranging items on the computer monitor screen surface, especially key words for the requirements of web browser user lying in monitoring the eye with a camera in the course of subsequent turning off and turning on the sources of light, which are placed in camera axis or in corners of the computer monitor and/or anywhere near them, recording constellations of reflections from pupil's surface in the camera image and processing the camera image by the computer and software, and as a result on establishing eyesight fixation points, is characterised by the fact that it measures the relation between the period of time when the user covered the area of the selected surface of the presented object with his eyes, and the overall period when the entity was displayed, and/or it measures the relation between the surface covered with user's eyes and the overall surface of the displayed element.

9. According to the invention, the manner of ranging items on the computer monitor screen surface, especially key words for the requirements of web browser user lying in monitoring the eye with a camera in the course of subsequent turning off and turning on the sources of light, which are placed in camera axis or in corners of the computer monitor and/or anywhere near them, recording constellations of reflections from pupil's surface in the camera image and processing the camera image by the computer and software, and as a result on establishing eyesight fixation points, is characterised by the fact that it monitors the shifting of user's eyes on the surface of the observed element, and when the eyesight reaches the final fragment of the object, positive key word, or letter, or note, another object is being displayed, the following page of an e-book or a note chart.

10. According to the invention, the manner of ranging the items on the monitor screen surface, especially key words for the requirements of the Internet browser user, based on monitoring the eye by means of a camera during the following switching on and switching off the light sources, which are placed in the axis of the camera and in corners of computer monitor and/or near them, based on recording the constellation of reflexes from surface of the pupil in the image of the camera and processing the camera image by the computer and by software, and as a result on setting the eyesight fixation point, which is characterized by the fact that it measures the relation between time when the user covered the area of the selected surface of the displayed item with his eyes and the total period of time when the element was displayed and/or it measures the relation between the surface covered with user's eyes and the overall surface of the displayed item.
